(19) United States
(12) Patent Application Publication
(10) Pub. No.: US 2026/0021719 A1
(43) Pub. Date: Jan. 22, 2026

(54) POWER SUPPLY CIRCUIT FOR A VEHICLE ELECTRICAL ENERGY STORAGE UNIT

(71) Applicant: VALEO ELECTRIFICATION, Cergy Pontoise (FR)

(72) Inventor: Nicolas ALLALI, Cergy Pontoise (FR)

(73) Assignee: VALEO ELECTRIFICATION, Cergy Pontoise (FR)

(21) Appl. No.: 19/106,307

(22) PCT Filed: Sep. 22, 2023
(86) PCT No.: PCT/EP2023/076300

§ 371 Date: Feb. 25, 2025

(30) Foreign Application Priority Data
Sep. 30, 2022 (FR) FR2209975

(51) Int. Cl. B60L 53/122; H02J 7/02; H02J 50/12; H02M 1/42; H02M 7/219

(52) U.S. Cl. CPC B60L 53/122; H02J 7/02; H02J 50/12; H02M 1/4233; H02M 7/219; H02J 2207/20

(57) ABSTRACT

A power supply circuit includes a primary sub-circuit and the secondary sub-circuit configured to exchange electrical energy via inductive coupling at the frequency of the alternating voltage at the input of the primary sub-circuit. The primary sub-circuit includes, for each phase of the alternating voltage at its input, first, second and third switching arms connected in parallel. The first switching arm includes two controllable electronic switches in series, between which a first terminal of the phase of a network is connected. The second switching arm includes two controllable electronic switches in series, between which a second terminal of the phase of the network is connected, and between which a first terminal of a primary inductive cell for contactless energy exchange is connected. The third switching arm includes two controllable electronic switches in series, between which a second terminal of the primary inductive cell for contactless energy exchange is connected.

The present invention relates to a contactless electric power supply circuit for an electrical energy storage unit of a vehicle.

The electrical energy storage unit has, for example, a nominal voltage of 12 V, 48 V, 60 V or more, for example greater than 300 V, for example 400 V, 800 V or 1000 V.

It is known practice to supply electric power, using contactless transmission by way of inductive coupling, to an electrical energy storage unit of a vehicle at a power of between 3 and 50 kW when the vehicle is at a standstill or when it is moving. This supply of power by way of contactless transmission is then achieved by means of remote electrical subcircuits that are magnetically coupled and tuned to the same resonant frequency. The magnetically coupled subcircuits each implement an LC resonant cell.

However, in order to transmit a satisfactory power level, in particular several kW, it is necessary to operate at high frequencies, in particular of the order of 85 kHz or more, as regards the resonant frequency of each resonant subcircuit. Furthermore, this type of solution requires a small distance between the two subcircuits. The frequency and power levels mentioned above, for an implementation in kW, may furthermore constitute a health risk for people exposed in the vicinity, or a risk for the environment in general.

US 2020/287468 and CN 113 765 358 disclose transformers and do not specify the frequency at which electrical energy is transferred via the magnetic circuit of the transformer.

There is a need to supply electric power to an electrical energy storage unit using contactless transmission that overcomes the aforementioned drawbacks.

The object of the invention is to meet this need and this is done, according to one of the aspects of the invention, using an electric power supply circuit for an electrical energy storage unit, this electric power supply circuit comprising:
a primary subcircuit able to be connected to a voltage network,
a secondary subcircuit able to be connected to an electrical energy storage unit, and
a control unit,
   the primary subcircuit and the secondary subcircuit being configured to contactlessly exchange electrical energy by way of inductive coupling at the frequency of the AC voltage at the input of the primary subcircuit,
   the primary subcircuit comprising, for each phase of the AC voltage, at its input:
a first switching arm, comprising two controllable electronic switches in series, between which a first terminal of the phase of the network is able to be connected,
a second switching arm, comprising two controllable electronic switches in series, between which a second terminal of the phase of the network is able to be connected, and between which a first terminal of a primary inductive cell for the contactless exchange of energy is connected, and
a third switching arm, comprising two controllable electronic switches in series, between which a second terminal of the primary inductive cell for the contactless exchange of energy is connected,
   the first, second, and third arms being connected in parallel, and the control unit being configured to control these first, second, and third switching arms in such a way that:
the first and second arms form a first inverter/rectifier, and
the second and third arms form a second inverter/rectifier.

Contactlessly exchanging electrical energy by way of inductive coupling at the frequency of the AC voltage at the input of the primary subcircuit makes it possible to overcome the aforementioned drawbacks in relation to the high frequency levels according to the prior art.

The implementation of two inverters/rectifiers having a common switching arm also makes it possible to reduce the bulk and costs associated with the primary subcircuit.

The electrical network provides, for example, a nominal RMS voltage of 230 V having a frequency of 50 Hz or 60 Hz. The electrical network is, for example, single-phase.

The electrical network is, for example, a regional or national electrical network. As a variant, this may be an independent local network comprising, for example, one or more batteries powered by energy sources such as wind turbines, solar panels, fuel cells or hydroelectric generators.

The control unit is, for example, configured to control the first and second arms in such a way that the first arm switches at a frequency greater than at least five times, in particular than at least ten times, the frequency at which the second arm switches, the second arm switching at the frequency of the AC voltage at the input of the primary subcircuit. In the context of the present invention, when an arm switches, each of its two controllable electronic switches is opened and closed in a complementary manner with the same switching frequency.

As already mentioned, the second arm may switch at a frequency of less than or equal to 60 Hz, in particular less than or equal to 50 Hz. The first arm may then switch at a frequency of greater than 250 Hz, in particular greater than 500 Hz. This switching frequency of the first arm is, for example, less than 1 MHz, in particular less than 500 kHz.

The control unit may be configured to control the second and third arms in such a way that these two arms switch at the same frequency, and that the third arm is phase-shift modulated with respect to the second arm, these two arms switching at the frequency of the AC voltage at the input of the primary subcircuit. As already mentioned, the second and third arms may switch at a frequency of less than or equal to 60 Hz, in particular less than or equal to 50 Hz. By way of example, this modulated phase shift allows the power transmitted to the secondary subcircuit to be regulated.

The control unit may be configured to control the first and second arms in such a way that these two arms furthermore perform a power factor correction function. Such a correction makes it possible, in a known manner, for the current drawn from the network to be as close as possible to a perfect sine at the angular frequency of the network. This reduces the reactive current and the subharmonics that increase the energy conduction losses.

The primary subcircuit comprises a primary inductive cell interacting with a secondary inductive cell of the secondary subcircuit for the contactless exchange of electrical energy by way of inductive coupling. The primary inductive cell may comprise, in series: a coil allowing magnetic energy to be generated, and a capacitor, thus forming a resonant cell, and the secondary inductive cell may comprise, in series: a coil allowing the magnetic energy from the primary inductive cell to be recovered, and a capacitor, thus forming a resonant cell. Where appropriate, these coils and these capacitors are chosen in such a way that the primary inductive cell and the secondary inductive cell have the same resonant frequency.

The secondary subcircuit may comprise:
the secondary inductive cell for the contactless exchange of energy, and
a third inverter/rectifier able to carry out impedance matching on the impedance at the AC input of this third inverter/rectifier independently of the impedance of the electrical energy storage unit.

The impedance at the AC input of the third inverter/rectifier is represented by the ratio V/I where V is the voltage across the terminals of the secondary inductive cell and I is the current flowing through it.

Impedance matching thus makes it possible to impose, on the AC input of the third inverter/rectifier, an impedance that is independent of that of the electrical energy storage unit, thereby promoting the contactless exchange of electrical energy at low frequency by way of inductive coupling.

In one example, the third inverter/rectifier comprises two switching arms connected in parallel, and each of these switching arms comprises two controllable electronic switches connected in series, the control unit being configured to control these two arms in such a way that:
one of these two arms switches at the frequency of the AC voltage at the input of the primary subcircuit and with a duty cycle of 50%, and
the other of these two arms switches at a frequency greater than that of said AC voltage, for example at a frequency greater than at least five times, in particular than at least ten times, the frequency of said AC voltage and with a duty cycle modulated according to the AC current flowing through the second inductive cell and the voltage at the AC input of the third inverter/rectifier. This frequency, which is greater than that of the AC voltage at which this arm of the third inverter/rectifier switches, is, for example, the same as that at which the first arm switches.

As another variant, the third inverter/rectifier comprises two switching arms connected in parallel, and each of these switching arms comprises two switches connected in series, only one switch out of the two switches of an arm being controllable, and the control unit being configured to control these two arms so as to carry out impedance matching on the AC input of this third inverter/rectifier.

In all of the above, the control unit may be configured to control the various switching arms so as to selectively:
charge the electrical energy storage unit from the voltage network, or
charge the voltage network from the electrical energy storage unit.

Therefore, electrical energy may be exchanged in one direction or in the other as required.

In all of the above, the electrical energy storage unit may be a lithium-ion battery. This battery has, for example, a nominal voltage of 12 V, 48 V, 60 V or more, for example greater than 300 V, for example 400 V, 800 V or 1000 V.

In all of the above, each controllable electronic switch is, for example, a transistor, for example, a bipolar, MOS or IGBT transistor, or a thyristor. Each controllable electronic switch is, for example, bidirectional.

In all of the above, the control unit may be a digital processing circuit, for example an ASIC (application-specific integrated circuit) or a microcontroller.

The control unit may, as a variant, comprise a primary subcircuit control module and a secondary subcircuit control module.

In all the above, the first and/or second inductor may be made of metal wire, such as copper wire.

Such a metal wire is solid, as opposed to Litz wire. A solid metal wire does not have a hollow cross section. As a variant, at least one of these inductors, or even each of these inductors, is made of Litz wire.

Another subject of the invention, according to another of its aspects, is a component for supplying electric power to an electrical energy storage unit, comprising the electrical circuit as defined above, the component in particular defining a structure supporting the primary subcircuit and the secondary subcircuit such that they are rigidly coupled to one another. Such a component is commonly called an “on-board charger”. This component is able to be placed on board a hybrid or electric vehicle.

Another subject of the invention, according to another of its aspects, is a device for supplying electric power to an electrical energy storage unit, comprising:
a charging station for a hybrid or electric vehicle, in which station the primary subcircuit of the electrical circuit as defined above is placed, and
a component able to be placed on board a hybrid or electric vehicle, in which the secondary subcircuit of the electrical circuit as defined above is placed.

This terminal then receives electrical energy from an electrical network via a cable, which may be a single-phase cable or a three-phase cable. In this case, the primary circuit and the secondary circuit are not integrated into the same physical component.

The invention will be able to be understood better upon reading the following description of a non-limiting exemplary implementation thereof and upon studying the appended drawing, in which:

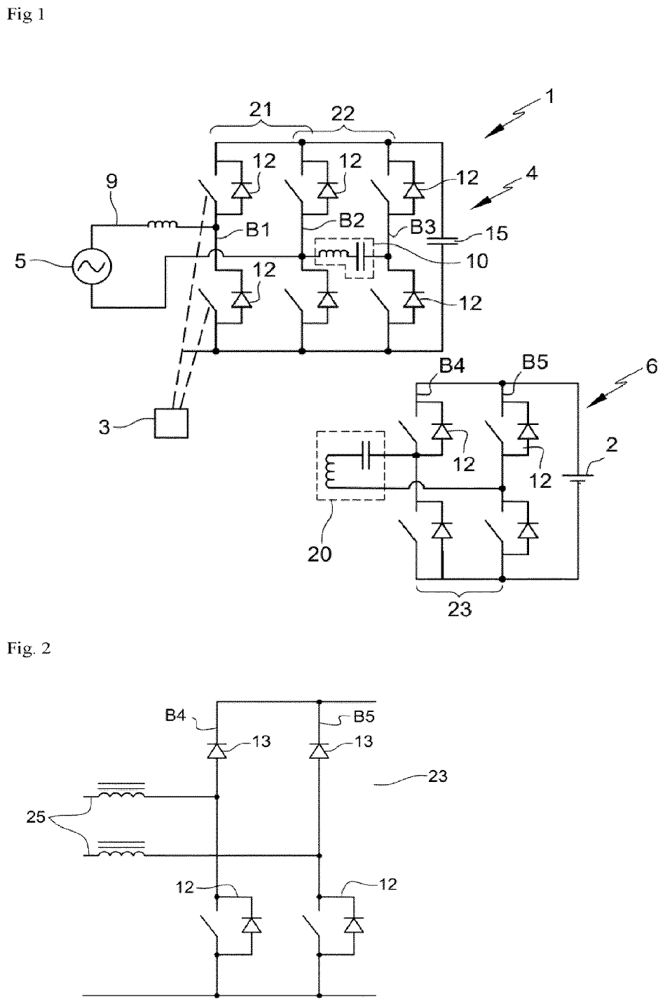

FIG. 1 schematically shows an electric power supply circuit according to one exemplary implementation of the invention, and

FIG. 2 schematically shows a variant of the third inverter/rectifier of the secondary subcircuit.

FIG. 1 shows an electric power supply circuit 1 for an electrical energy storage unit 2. This electrical energy storage unit 2 is, for example, a vehicle battery, which may have a nominal voltage of 48 V, 60 V, 300 V, 400 V, 800 V or more. This battery is used to supply power to a drive system of an electric or hybrid vehicle.

This electric power supply circuit 1 comprises:
a control unit 3,
a primary subcircuit 4 able to be connected to a voltage network 5, and
a secondary subcircuit 6, comprising the electrical energy storage unit 2.

The electric power supply circuit 1 implements a contactless exchange of electrical energy, by way of inductive coupling, between the primary subcircuit 3 and the secondary subcircuit 6 in order to charge the electrical energy storage unit 2.

In the example in question, the primary subcircuit 4 comprises:
a connector 9 able to be connected to the electrical network,
three switching arms B1, B2 and B3, which are connected in parallel and the operation of which will be described below, and
a primary inductive cell 10, the operation of which will be described below.

The electrical network 5 provides, for example, a nominal RMS voltage of 230 V having a frequency of 50 Hz or 60 Hz. In this case, the electrical network 5 is single-phase, and so the connector 9 is also single-phase.

In this case, each arm B1, B2 and B3 of the primary subcircuit 4 comprises two controllable electronic switches 12 connected in series, such as MOS, IGBT or bipolar transistors, or thyristors.

The first arm B1 thus comprises two controllable electronic switches 12 in series, between which a first terminal of the network 5 is able to be connected, in this case via a smoothing coil.

The second arm B2 thus comprises two controllable electronic switches 12 in series, between which a second terminal of the network 5 is able to be connected, and between which a first terminal of the primary inductive cell 10 for the contactless exchange of energy is connected.

The third arm B3 thus comprises two controllable electronic switches 12 in series, between which a second terminal of the primary inductive cell 10 for the contactless exchange of energy is connected.

In this case, the primary inductive cell 10 comprises, in series: a coil allowing magnetic energy to be generated, and a capacitor, thus forming a resonant cell. The coil has, for example, an inductance of between 1 mH and 100 mH and the capacitor has a capacitance of between 100 μF and 100 mF.

It may be seen that a capacitor 15 is arranged in parallel with the three switching arms B1 to B3. The latter has, for example, a capacitance of between 1 μF and 1 mF, for example 10 μF.

A first example of a secondary subcircuit 6 will now be described with reference to FIG. 1. This secondary subcircuit 6 comprises a secondary inductive cell 20 for the contactless exchange of energy with the primary inductive cell 10, and
an inverter/rectifier 23, also called a “third inverter/rectifier” below, able to carry out equivalent impedance matching on its AC input (therefore on the side of the secondary inductive cell 20), so as to make this impedance vary independently of the impedance of the electrical energy storage unit 2.

As may be seen in FIG. 2, the secondary inductive cell 20 in this case comprises, in series: a coil allowing the magnetic energy from the primary inductive cell 10 to be recovered, and a capacitor 30, thus forming a resonant cell. In the example in question, the coil has an inductance of between 1 mH and 100 mH and the capacitor has a capacitance of between 100 μF and 100 mF.

In the example described, the inverter/rectifier 23 comprises two switching arms B4 and B5, each arm comprising two controllable electronic switches 12 in series, between which a terminal of the secondary inductive cell 20 for contactless energy exchange is connected.

Controlling the inverter/rectifier 23 makes it possible, for example, to make the equivalent impedance R_{Ref} at the terminals of the AC input, defined between the two midpoints of the arms, vary independently of the impedance at the output of this inverter/rectifier 23.

The equivalent impedance R_{Ref} is represented by the ratio V/I where V is the voltage across the terminals of the AC input and I is the current at this AC input.

R_{Ref} has, for example, a resistance of between 5′Ω and 15′Ω. For a given recharging configuration, this configuration being determined in particular by at least one of: the position of the secondary subcircuit 6 in relation to the primary subcircuit 4 and/or the level of power to be transmitted and/or the voltage Vbatt across the terminals of the electrical energy storage unit 2, R_{Ref} may have a fixed resistance and this resistance is, for example, in the aforementioned range. From one recharging configuration to another, for example in the event of greater distance between the primary subcircuit 4 and the secondary subcircuit 6 and/or to take account of the ageing of the system, the resistance of R_{Ref} may be modified, remaining in particular within the aforementioned range.

The inverter/rectifier 23 in FIG. 1 is, for example, controlled by the control unit 3 as follows to carry out impedance matching on the AC input of the third inverter/rectifier 23:
one of the two arms B4 or B5 switches at the frequency of the network 5 and with a duty cycle of 50%, and
the other of the two arms B5 or B4 switches at a frequency greater than that of the network 5, for example at least 5 times or 10 times the frequency of the network, and with a duty cycle modulated according to the AC current measured at the output of the secondary inductive cell 20 and according to the voltage across the terminals of the AC input of this third inverter/rectifier 23. One of the controllable switches of the arm B4 or B5, which switches at a frequency greater than that of the power transmitted from the primary subcircuit 4 is, for example, driven with a duty cycle α, while the other controllable switch of this arm B4 or B5 is driven with a duty cycle 1−α, and α is, for example, determined according to the equation below

$$∞ = R\_ ( Ref \times \vert I \vert ) / V\_batt$$

As a variant, as shown in FIG. 2, the third inverter/rectifier 23 may be formed in a different way. The two switching arms B4 and B5 then each comprise two electronic switches in series:
a controllable electronic switch 12 between the connection to the secondary inductive cell 20 and the negative terminal of the electrical energy storage unit 2, and
a diode 13 between the connection to the secondary inductive cell 20 and the positive terminal of the electrical energy storage unit 2.

Each connection to the secondary inductive cell 20 of a switching arm B4 or B5 is made via a coil 25 of the secondary inductive cell 20.

The manner in which the arms B1 to B3 of the primary subcircuit 4 are controlled will now be described.

In the example in question, the control unit 3 is configured to control the first and second arms B1 and B2 in such a way that the first arm B1 switches at a frequency greater than at least five times, in particular than at least ten times, the frequency at which the second arm B2 switches, the second arm B2 switching at the frequency of the network 5. By way of example, the switching frequency at which the first arm B1 switches is the same as that at which the arm B4 or B5 that does not switch at the frequency of the network 5 switches.

As already mentioned, in this case the second arm B2 switches at the frequency of the network 5, in this case 50 Hz or 60 Hz.

This control of the first and second arms B1 and B2 allows the latter to form a first inverter/rectifier 21. Where appropriate, this control of the arms B1 and B2 may also allow these two arms B1 and B2 to furthermore perform a power factor correction function. By way of example, the two arms B1 and B2 form a “totem-pole PFC rectifier” or “dual-boost PFC rectifier” assembly known in the electronics literature as an assembly.

In addition to what has just been stated, in this case, the control unit 3 is configured to control the second and third arms B2 and B3 in such a way that these two arms switch at the same frequency, which in this case is that of the network 5, and in such a way that the third arm B3 is phase-shift modulated with respect to the second arm B2. This control of the second and third arms B2 and B3 allows the latter to form a second inverter/rectifier 22.

The invention is not limited to the example that has just been described.

1. An electric power supply circuit for an electrical energy storage unit, this electric power supply circuit comprising:
a primary subcircuit able to be connected to a voltage network,
a secondary subcircuit able to be connected to an electrical energy storage unit, and
a control unit,
the primary subcircuit and the secondary subcircuit being configured to contactlessly exchange electrical energy by way of inductive coupling at the frequency of the AC voltage at the input of the primary subcircuit,
the primary subcircuit comprising, for each phase of the AC voltage, at its input:
a first switching arm, comprising two controllable electronic switches in series, between which a first terminal of the phase of the network is able to be connected,
a second switching arm, comprising two controllable electronic switches in series, between which a second terminal of the phase of the network is able to be connected, and between which a first terminal of a primary inductive cell for the contactless exchange of energy is connected, and
a third switching arm, comprising two controllable electronic switches in series, between which a second terminal of the primary inductive cell for the contactless exchange of energy is connected,
the first, second, and third arms being connected in parallel, and the control unit being configured to control these first, second, and third switching arms in such a way that:
the first and second arms form a first inverter/rectifier, and
the second and third arms form a second inverter/rectifier.

2. The circuit as claimed in claim 1, the control unit being configured to control the first and second arms in such a way that the first arm switches at a frequency greater than at least five times, in particular than at least ten times, the frequency at which the second arm switches, the second arm switching at the frequency of the AC voltage at the input of the primary subcircuit.

3. The circuit as claimed in claim 2, the second arm switching at a frequency of less than or equal to 60 Hz, in particular less than or equal to 50 Hz.

4. The circuit as claimed in claim 1, the control unit being configured to control the second and third arms in such a way that these two arms switch at the same frequency, and that the third arm is phase-shift modulated with respect to the second arm, these two arms switching at the frequency of the AC voltage at the input of the primary subcircuit.

5. The circuit as claimed in claim 4, the second and third arms switching at a frequency of less than or equal to 60 Hz, in particular less than or equal to 50 Hz.

6. The circuit as claimed in claim 1, the control unit being configured to control the first and second arms in such a way that these two arms furthermore perform a power factor correction function.

7. The circuit as claimed in claim 1, the secondary subcircuit comprising:
a secondary inductive cell for the contactless exchange of energy, and
a third inverter/rectifier able to carry out impedance matching on the impedance at the AC input of this third inverter/rectifier independently of the impedance of the electrical energy storage unit.

8. The circuit as claimed in claim 7, the third inverter/rectifier comprising two switching arms connected in parallel, the control unit being configured to control these two arms in such a way that:
one of these two arms switches at the frequency of the AC voltage at the input of the primary subcircuit and with a duty cycle of 50%, and
the other of these two arms switches at a frequency greater than that of said AC voltage and with a duty cycle modulated according to the AC current flowing through the secondary inductive cell and the voltage at the AC input of the third inverter/rectifier.

9. The circuit as claimed in claim 1, the control unit being configured to control the various switching arms so as to selectively:
charge the electrical energy storage unit from the voltage network, or
charge the voltage network from the electrical energy storage unit.

10. A component for supplying electric power to an electrical energy storage unit, comprising the electrical circuit as claimed in claim 1, the component in particular defining a structure supporting the primary subcircuit and the secondary subcircuit such that they are rigidly coupled to one another.

11. A device for supplying electric power to an electrical energy storage unit, comprising the electric power supply circuit of claim 1, wherein
the primary subcircuit is placed in a charging station for a hybrid or electric vehicle, and
the secondary subcircuit is placed in a component able to be placed on board a hybrid or electric vehicle.

12. The circuit as claimed in claim 2, the control unit being configured to control the second and third arms in such a way that these two arms switch at the same frequency, and that the third arm is phase-shift modulated with respect to the second arm, these two arms switching at the frequency of the AC voltage at the input of the primary subcircuit.

13. The circuit as claimed in claim 2, the control unit being configured to control the first and second arms in such a way that these two arms furthermore perform a power factor correction function.

14. The circuit as claimed in claim 2, the secondary subcircuit comprising:
a secondary inductive cell for the contactless exchange of energy, and
a third inverter/rectifier able to carry out impedance matching on the impedance at the AC input of this third inverter/rectifier independently of the impedance of the electrical energy storage unit.

15. The circuit as claimed in claim 2, the control unit being configured to control the various switching arms so as to selectively:
charge the electrical energy storage unit from the voltage network, or
charge the voltage network from the electrical energy storage unit.

16. A component for supplying electric power to an electrical energy storage unit, comprising the electrical circuit as claimed in claim 2, the component in particular defining a structure supporting the primary subcircuit and the secondary subcircuit such that they are rigidly coupled to one another.

17. A device for supplying electric power to an electrical energy storage unit, comprising the electric power supply circuit of claim 2, wherein
the primary subcircuit is placed in a charging station for a hybrid or electric vehicle, and
the secondary subcircuit is placed in a component able to be placed on board a hybrid or electric vehicle.

18. The circuit as claimed in claim 3, the control unit being configured to control the second and third arms in such a way that these two arms switch at the same frequency, and that the third arm is phase-shift modulated with respect to the second arm, these two arms switching at the frequency of the AC voltage at the input of the primary subcircuit.

19. The circuit as claimed in claim 3, the control unit being configured to control the first and second arms in such a way that these two arms furthermore perform a power factor correction function.

20. The circuit as claimed in claim 3, the secondary subcircuit comprising:
a secondary inductive cell for the contactless exchange of energy, and
a third inverter/rectifier able to carry out impedance matching on the impedance at the AC input of this third inverter/rectifier independently of the impedance of the electrical energy storage unit.
